(19) United States
(12) Patent Application Publication
(10) Pub. No.: US 2006/0093775 A1
(43) Pub. Date: May 4, 2006

(54) Process for coating web substrates with at least two adhesives, adhesive tape produced by the process, and its use

(75) Inventors: Sven Konig, Grand Rapids, MI (US); Andree Bernoth, Hamburg (DE); Robert Hoppner, Marxen (DE); Thomas Hagen, Hamburg (DE); Steven Marquardt, Hamburg (DE); Irfan Ertas, Hamburg (DE); Michael Evers, Guderhandviertel (DE)

Correspondence Address: NORRIS, MCLAUGHLIN & MARCUS, PA, 875 THIRD AVENUE, 18TH FLOOR, NEW YORK, NY, 10022, US

(73) Assignee: tesa AG, Hamburg (DE)

(21) Appl. No.: 11/010,746

(22) Filed: Dec. 13, 2004

(30) Foreign Application Priority Data
Nov. 4, 2004 (DE) 10 2004 053 189.7

(51) Int. Cl. B32B 33/00

(52) U.S. Cl. 428/40.1; 156/289; 156/295

(57) ABSTRACT

The invention relates to a process for coating web substrates (10), the substrate (10) being coated over at least part of its area with a first adhesive (12) and thereafter the substrate (10) coated with the first adhesive (12) being coated over at least part of its area with at least one second, further adhesive (14).

Provision is made for the first adhesive (12) to be still wet or not yet cured when it is coated with the further adhesive (14).

The invention relates to a process for coating substrates in web form with at least two adhesives (one or two adhesives but two lines, overlapping or alongside one another), to an adhesive tape produced by the process, and to its use.

Self-adhesive articles consist of at least two layers, these being a non-self-adhesive substrate (backing layer) and, applied to it, a pressure-sensitive adhesive. A double-sided self-adhesive tape is generally applied from at least three layers, these being the substrate and the adhesive layers applied to it on either side. There are also products known which on one side of the substrate have two or more adhesive layers, these being applied to the substrate partly or completely overlapping one another or else alongside one another. In this case, for example, the bottom layer of two adhesive layers may serve as an adhesion promoter between the substrate and the upper adhesive layer. In this instance complete overlap of the two adhesive layers is appropriate. There are also adhesive tapes known, however, which have two or more strips of adhesive arranged alongside one another or with only a partial overlap. With different adhesive properties of the adhesive materials used, a multifunctional adhesive tape of this kind is capable of attaching to different materials to be bonded. Additionally such adhesive tapes find use as auxiliary systems in connection with splicing, when ends of two webs of material are joined to one another, or for the purpose of implementing a flying reel changeover of continuous web materials, as in the printing industry, for example.

According to customary processes for producing adhesive tapes a web substrate, produced separately, is coated with the fluid or spreadable adhesive. Coating normally takes place from a solution, for which purpose the pressure-sensitive adhesive is converted into a spreadable consistency with the aid of solvents prior to coating. Depending on the adhesive composition, however, coating may also take place from the melt, solventlessly, in an extrusion process. This process has become established particularly for pressure-sensitive adhesives based on thermoplastic elastomers. Another way of establishing the connection between substrate and pressure-sensitive adhesive is first to apply the pressure-sensitive adhesive to a dehesive medium to form a film thereon and subsequently, in a laminating process, applying the adhesive film to the backing.

All of the processes referred to are also employed for producing adhesive tapes having two or more adhesive layers. Where production takes place from the solution or the melt the coating operations are performed in succession after the lower adhesive layer in each case has dried or cured. Because of the multiplicity of worksteps required, this approach is inconvenient and costly. Multiple coating by a laminating process carries the problem of low dimensional accuracy when one line of adhesive is applied to a previous one.

It is an object of the invention, therefore, to provide a simple and inexpensive process for producing adhesive tapes having two or more adhesive layers.

This object is achieved by a process having the features of Claim 1. By virtue of the fact that the web substrate is first coated over at least part of its area with a first adhesive and thereafter coated over at least part of its area with a further adhesive while the first adhesive is still wet or has not yet cured, the process can be carried out with a minimal number of process stages. The individual coating operations can take place virtually in one work cycle, without the need for otherwise-necessary drying or curing stages in between. Particular advantages arise, moreover, in the case where the adhesives are coated partly or completely over one another. In this case, indeed, there is partial diffusion of the layers into one another, so that the anchoring of the adhesives with one another is substantially better when they are crosslinked on the web. The application with the adhesives in immediate succession can be carried out, moreover, with a high level of dimensional accuracy in terms of the site of application on the substrate or on the adhesive layer applied previously.

In the process the individual adhesive layers, which may be composed of the same or different adhesive compositions, can be applied to the substrate partly or completely overlapping one another or else alongside one another (not overlapping). The substrate may also be coated on one or both sides, it being possible to coat the individual sides with the at least two adhesives over part or all of their area in each case.

The individual adhesives are preferably applied to the substrate in a known way, from a solution, with additional solvents, or from a melt, with thermal heating, in an extrusion process. Depending on the nature of the process and on the adhesives used, customary coating methods are appropriate here, examples being brush application, extrusion, spray application, roll application and/or knife coating. The said processes and methods can also be combined with one another. Thus, for example, it is possible to spray-apply the first adhesive as a solution and to apply the second adhesive as a melt, or else in reverse sequence, to the substrate by means of rolling or knife coating.

Known base polymers for the adhesive layer include natural rubbers and synthetic rubbers, polyacrylates, block copolymers containing polystyrene block functions, polyethylene-vinylacetates, and polyurethanes. They are generally used in combination with additions such as resins and plasticizers and/or or other auxiliaries, examples being antioxidants, UV stabilizers or rheological additives and also fillers. In combination with the substrate employed, the adhesive critically determines the pressure-sensitive adhesion properties of the self-adhesive article, such as bond strength, peel release, redetachability, et cetera.

Suitable non-adhesive substrate materials include any materials in web form, examples being papers, woven fabrics, nonwovens, polymeric films or elastomers, each in different thicknesses, structures and polymer compositions.

According to one particular preferred embodiment of the invention, after the substrate has been coated with the adhesives, at least one release material layer, lining the adhesives, is applied. Release material layers of this kind, typically composed of PE or silicone-coated plastic or paper, are removed from the adhesive tape before it is employed for its intended bonding application, and serve to protect the adhesive layer and to prevent unwanted sticking. With particular preference in this context the at least two adhesive strips are applied alongside one another or partly overlapping on the substrate and are each lined with a release material layer which covers the corresponding adhesive strips. There may also be only one single release material layer, subdivided by a perforation seam.

The invention further provides an adhesive tape produced by the process of the invention, comprising a substrate in web form and at least two strips of adhesive arranged completely, partially or not overlapping one another on the substrate. According to one preferred embodiment the adhesive tape comprises at least one release material layer lining the at least two adhesive strips, and, where adhesive strips are arranged alongside one another or partly overlapping, they are preferably each lined with a release material layer.

Adhesive tapes of this kind can be used with particular advantage as a splicing system for joining ends of material webs, especially for implementing flying reel changeovers in continuous web materials.

Further advantageous embodiments of the invention are subject-matter of the other dependent claims.

The invention is illustrated below in exemplary embodiments with reference to the associated drawings, in which:

FIG. 1 shows a coating plant for implementing the process of the invention according to a first embodiment, with spray application of the adhesives;

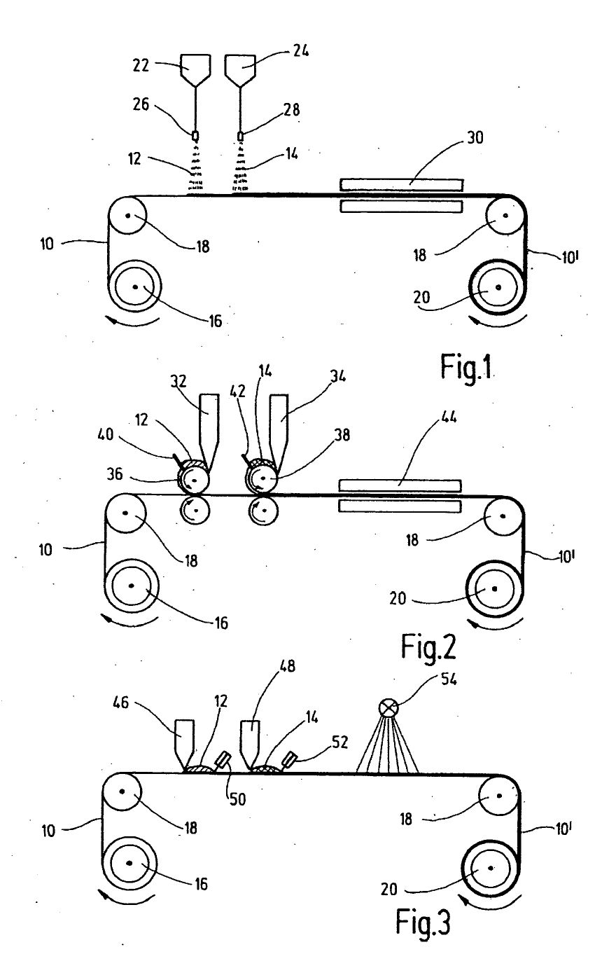

FIG. 2 shows a coating plant for implementing the process of the invention in accordance with a second embodiment, with roller application of the adhesives;

FIG. 3 shows a coating plant for implementing the process of the invention in accordance with a third embodiment, with an application of the adhesives with knife coating;

FIG. 4 shows an adhesive tape produced in accordance with the invention, in a cross-sectional view, and

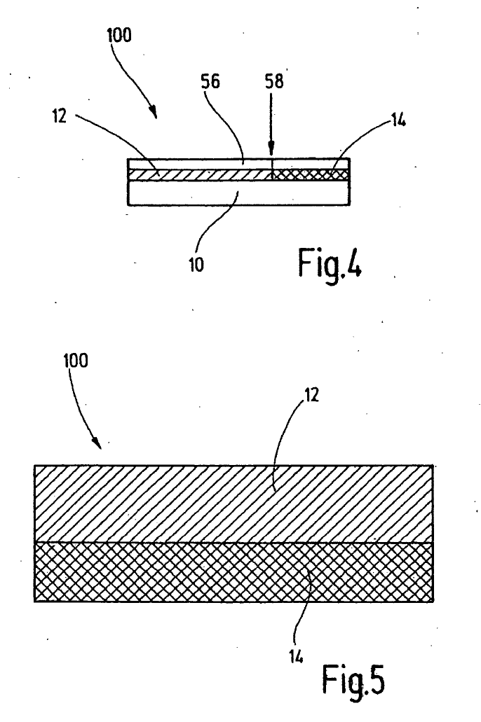

FIG. 5 shows an adhesive tape produced in accordance with the invention, in a plan view.

FIG. 1 shows, diagrammatically, a plant in which a web substrate 10 is coated in succession with a first adhesive 12 and with a second adhesive 14 by a spraying process. The incoming substrate web 10, as yet uncoated, is wound up on a rotatably mounted bale unwinder 16. Guided by two deflection rolls 18, it passes through the coating station and is taken up as coated substrate 10′ by the product winder 20. The substrate 10 is typically conveyed by an electrical motor, which is not shown but which drives, for example, the product winder 20.

According to the embodiment depicted, coating with the adhesives 12 and 14 takes place by spray application of their solutions. For this purpose the adhesives 12 and 14 are in solution in a suitable solvent, which may be an organic solvent or water. The corresponding solutions are each located in a vessel 22 or 24 respectively, which connects by line to a nozzle 26 or 28 respectively. The nozzles 26 and 28 are preferably designed as nozzles corresponding to a desired application width of the respective adhesive 12, 14. The desired spray profile can additionally be limited by baffles which though not shown here are disposed below the nozzles 26 and 28.

The spraying stations for the adhesives 12 and 14, which are situated in direct succession, apply the second adhesive 14 when the first adhesive 12 has still not dried. The drying and, where appropriate, polymerization/crosslinking of the two adhesives 12 and 14 instead takes place only in a downstream heating tunnel 30, through which the coated substrate 10′ passes. The polymerization of the adhesive monomers may also take place here, where appropriate. Alternatively there is electron beam crosslinking.

FIG. 2 depicts the coating of the substrate 10 with the two adhesives 12 and 14 from the melt. In this figure, identical reference numerals denote the same elements as in FIG. 1 and are not explained again individually. In the case of this process the adhesives 12 and 14 are melted and homogenized in a known way to form spreadable shaping compounds, in extruders which are not shown here but are separate from one another. The hot adhesives 12 and 14 are applied by means of corresponding extruder nozzles 32 (extrusion slot dies for the coating of web materials) and 34 to the successive roller units 36 and 38, with application to the web material by direct extrusion also being possible. Uniform spreading of the adhesives 12 and 14 on the corresponding rolls 36 and 38 is accomplished by the knife coaters 40 and 42, which can be adjusted at selectable distance from the substrate 10. The curing of the adhesives 12 and 14 that have been applied to the substrate 10 takes place by cooling and occurs spontaneously or can be accelerated—as shown—by a downstream cooling tunnel 44.

Alternatively to the implementation shown in FIG. 2, the melts (or solutions) can also be applied directly to the substrate 10, without rolls, and distributed thereon using knife coaters. Likewise known are plants wherein the melts (or solutions) are transferred via a roller mechanism consisting of two or more rolls, and are applied by roller to the substrate 10.

According to FIG. 3 the substrate 10 is coated with the adhesives 12 and 14 from the corresponding solutions, which are located in the vessels 46 and 48 respectively. In this case the spreadable solutions of the adhesives 12 and 14 are applied to the substrate 10 in succession via corresponding nozzles of the vessels 46 and 48 and are distributed as uniform layers on the substrate 10 by means of two knife coater installations 50 and 52 arranged at a distance from the substrate 10. The polymerization of the adhesive monomers is initiated for example by UV radiation, which is generated by a downstream UV radiation source 54.

In the coating plants shown in FIGS. 1 to 3 a unitary application method has been chosen in each case for the adhesives 12 and 14. It will be appreciated that the different processes can also be combined with one another. For example, the first adhesive 12 can be applied to the substrate 10 by spray application from solution, and the second adhesive 14 by means of the knife-coating technique shown in FIG. 3.

Additionally, coating of the adhesive side with a release material can take place in the same production stage, following application of the second adhesive 14.

In all of the exemplary embodiments shown the two coating stations for the two adhesives 12 and 14 are placed so closely in succession that the second adhesive 14 is applied “wet on wet” to the as-yet undried, uncured or unpolymerized first adhesive 12. The effect of this is to concentrate the coating process in terms of both time and location, with considerable cost savings. The curing of the adhesive layers 12 and 14 may take place in each case in a unitary station 30, 44 or 54. In the case of partial or complete overlap of the two adhesive layers 12 and 14, furthermore, improved anchoring of the adhesives to one another is produced.

Solvent-borne adhesives should never be applied beneath melts or beneath solvent-free systems in general, since these adhesives do not dry. Conversely, lower layers can be cured with electron beams, thermally or by UV—with UV on one side and only to a coat thickness of about 1 mm.

FIG. 4 shows an example of an adhesive tape 100, produced with the process of the invention, in a cross-sectional view along the width of the material (the thicknesses of material have been depicted on a massively enlarged scale). Located alongside one another on the substrate 10 are the first adhesive layer 12 and the second adhesive layer 14. Additionally the adhesive layers 12 and 14 have been covered by a removable release material layer 56. Along the interface between the adhesive layers 12 and 14 the release material 56 features a perforation seam 58, which allows the strips of release material to be removed separately. Alternatively it is also possible for two, adhesive-individual strips of release material to be provided.

A plan view of the adhesive tape 100 following removal of the release material layer 56 is shown in FIG. 5.

The product 100 depicted in FIGS. 4 and 5 can be used with particular advantage for splicing web materials, as in the printing industry, for example.

### Reference Numerals

100 adhesive tape
10 substrate
10′ coated substrate
12 first adhesive
14 second adhesive
16 bale unwinder
18 deflection roll
20 product winder
22, 24 vessel
26, 28 nozzle
30 heating tunnel
32, 34 extruder nozzle
36, 38 roller unit
40, 42 knife coater
44 cooling tunnel
46, 48 vessel
50, 52 knife-coater installation
54 UV radiation source
56 release material layer
58 perforation seam

1. Process for coating a web substrates, comprising coating the substrate over at least part of its area with a first adhesive and thereafter coating the substrate over at least part of its area with at least one further, second adhesive wherein the first adhesive is still wet or is not yet cured when it is coated with the further adhesive.

2. Process according to claim 1, wherein the first adhesive and/or the at least one further adhesive is/are applied to the substrate partly or completely overlapping or alongside one another.

3. Process according to claim 1, wherein the substrate is coated on one or both sides, in each case over part or all of its area.

4. Process according to claim 1, wherein the first adhesive and/or the at least one further adhesive is/are applied to the substrate as a solution or as a melt.

5. Process according to claim 1, wherein the first adhesive and/or the at least one further adhesive is/are applied and distributed to the substrate by brushing, spraying, extrusion, casting, rolling and/or knife coating.

6. Process according to claim 1, wherein the first adhesive and/or the at least one further adhesive are composed of the same or different adhesive compositions.

7. Process according to claim 1, wherein after the substrate has been coated with the first adhesive and with the at least one further adhesive at least one release material layer, lining at least one of the adhesives is applied.

8. Process according to claim 7, wherein at least two adhesives are applied to the substrate alongside one another or partly overlapping and are each lined with a release material layer.

9. Adhesive tape produced according to claim 1, comprising a web substrate and at least two adhesive layers arranged completely, partly or not overlapping one another on the substrate.

10. Adhesive tape according to claim 9, wherein at least one release material layer lines the at least two adhesive layers.

11. Adhesive tape according to claim 10, wherein at least two adhesive layers are arranged on one another or partly overlapping on the substrate and have each been lined with a release material layer.

12. A method comprising joining a first end of a first web material to a second end of a second web material with an adhesive tape according to claim 9.
